(19) United States
(12) Patent Application Publication
(10) Pub. No.: US 2019/0114082 A1
(43) Pub. Date: Apr. 18, 2019

(54) Coordination Of Compaction In A Distributed Storage System

(71) Applicant: HoneycombData Inc., Santa Clara, CA (US)

(72) Inventors: Yangyang Pan, Santa Clara, CA (US); Xiangyong Ouyang, San Jose, CA (US); Dongqi Xue, Santa Clara, CA (US); Chaoqun Zhu, San Jose, CA (US)

(21) Appl. No.: 15/786,142

(22) Filed: Oct. 17, 2017

(51) Int. Cl. G06F 3/06; G06F 17/30

(52) U.S. Cl. CPC G06F 3/065; G06F 17/30153; G06F 3/067; G06F 3/0608; G06F 3/0611

(57) ABSTRACT

A distributed storage system stores a storage volume as a primary replica and secondary replicas on one or more servers. Data is written in an append-only scheme and all write requests are completed for the primary and secondary replicas. Read requests are processed by the primary replicas. Compaction for the primary replica is performed only if no secondary replicas (or a minimum number) are being compacted and a server storing the primary replica is not currently compacting another replica. The primary replica is demoted to secondary prior to compaction and a secondary replica is promoted to primary. Compaction of the primary replica is also conditioned on bandwidth conditions being met on the server storing it. Secondary replicas are compacted only if no other secondary replicas are being compacted. Replicas are selected as eligible for compaction based on a number of updates to the replica meeting a threshold condition.

### BACKGROUND

### Field of the Invention

This invention relates to systems and methods for storing and accessing data in a distributed storage system.

### Background of the Invention

Many storage systems employ an append-only model to write data. Take an object store as an example. An object is identified with a unique key, and it has a value associated with it. When an object is being updated, it is appended to the end of the file. If this object already exists, its previous version is marked as invalid. Essentially an object's current value supersedes its previous value. An index data structure is updated to track the current values of all objects. As more updates are appended to the file, it will hit a size limit and the user will need to run a process called compaction to reclaim storage space used by invalid data. Compaction will scan the file, discard invalid data, merge valid data, write the valid data to a new file, and then delete the old file.

The compaction process has a significant impact on storage performance. Compaction consumes a lot of read/write storage bandwidth, so it will slow down user-issued read/write requests. It can lead to long tail latency for some of the user requests, and sometimes cause them to time out. If multiple object stores are located on a same storage device, compaction in one object store will cause performance degradation on its neighbor objects stores sharing the same storage device.

The system and methods described below provide an improved approach for managing compaction in a distributed storage system.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a computing system suitable for implementing methods in accordance with embodiments of the invention;

FIG. 2 is a schematic block diagram of components of a storage system in accordance with the prior art;

FIG. 3 is a schematic block diagram of a distributed storage system in accordance with an embodiment of the present invention;

FIG. 4 is a process flow diagram of a method for processing write commands in the distributed storage system in accordance with an embodiment of the present invention;

FIG. 5 is a process flow diagram of a method for processing read commands in the distributed storage system in accordance with an embodiment of the present invention; and

FIG. 6 is a process flow diagram of a method for compacting replicas of a storage volume in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

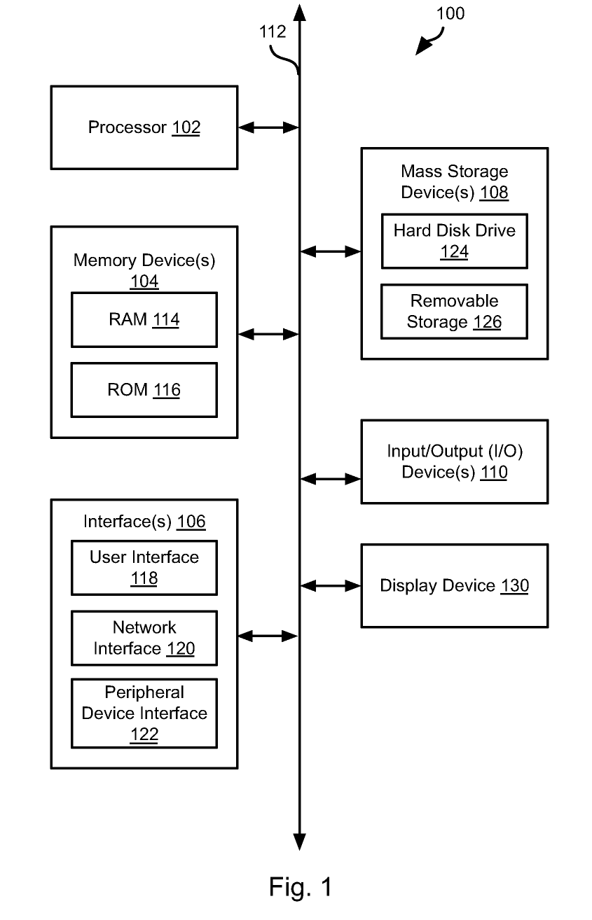

FIG. 1 is a block diagram illustrating an example computing device 100. Computing device 100 may be used to perform various procedures, such as those discussed herein. Computing device 100 can function as a server, a client, or any other computing entity. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). memory device(s) 104 may also include rewritable ROM, such as flash memory.

Mass storage device(s) 108 include various computer readable media, such as magnetic tapes, magnetic disks, optical disks, solid-state memory (e.g., flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

interface(s) 106 include various interfaces that allow computing device 100 to interact with other systems, devices, or computing environments. Example interface(s) 106 include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

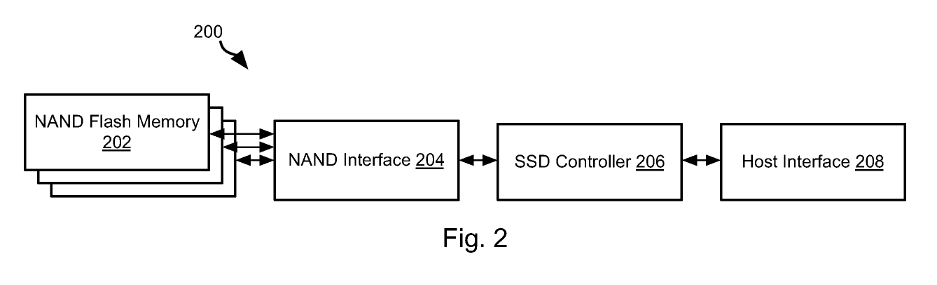

Referring to FIG. 2, a typically flash storage system 200 includes a solid state drive (SSD) may include a plurality of NAND flash memory devices 202. One or more NAND devices 202 may interface with a NAND interface 204 that interacts with an SSD controller 206. The SSD controller 206 may receive read and write instructions from a host interface 208 implemented on or for a host device, such as a device including some or all of the attributes of the computing device 100. The host interface 208 may be a data bus, memory controller, or other components of an input/output system of a computing device, such as the computing device 100 of FIG. 1.

The methods described below may be performed by the host, e.g. the host interface 208 alone or in combination with the SSD controller 206. The methods described below may be used in a flash storage system 200, hard disk drive (HDD), or any other type of non-volatile storage device. The methods described herein may be executed by any component in such a storage device or be performed completely or partially by a host processor coupled to the storage device.

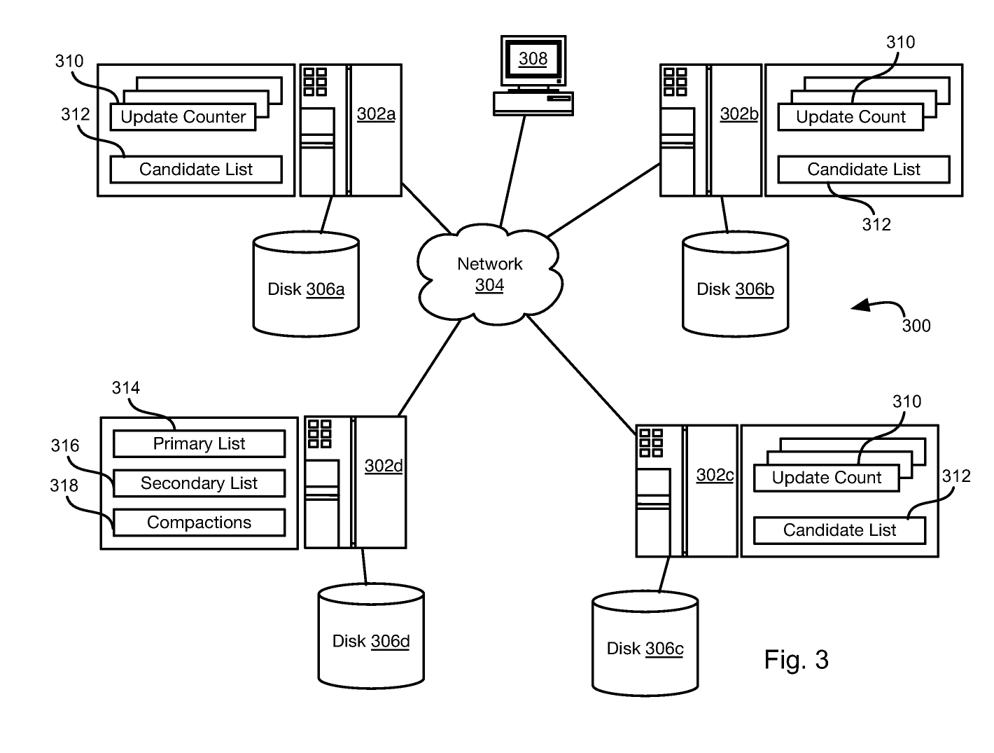

FIG. 3 illustrates an improved distributed storage system 300. The system 300 may include a plurality of servers 302a-302d that are coupled to one another by a network 304. The servers 302a-302d may be embodied as a computing device 100 or multiple computing devices 100. The servers 302a-302d may be collocated or distributed geographically. The network 304 may therefore be a local area network (LAN), a wide area network (WAN), or the Internet and may include any other wired or wireless network.

Each server 302a-302c may include a storage device 306a-306c, which may be embodied as a solid state drive (SSD), e.g., flash drive, a hard disk drive (HDD), or any other persistent storage device. The storage devices 306a-306c may be very large, e.g., greater than 100 GB, in order to provide large scale storage of data. Note that although each storage device 306a-306c is referred to in the singular throughout this description, in many instances each storage device 306a-306c may be comprised of multiple individual SSD, HDD, or other persistent storage devices.

Users may access the storage system 300 by means of a computer 308 coupled to the network or by accessing one of the servers 302a-302d directly. The computer 308 may be a desktop or laptop computer, tablet computer, smart phone, wearable computing device, or any other type of computing device.

As described in detail below, a storage volume may be stored in the storage devices 306a-306c such that multiple replicas of the storage volume are stored on multiple storage devices 306a-306c. The methods disclosed below provide an approach for coordinating compaction (also referred to as garbage collection) of the various replicas of a storage volume in order to reduce degradation of performance.

To accomplish this purpose, each server 302a-302c may store and update an update counter 310 for each replica of each storage volume stored on its corresponding storage device 306a-306c. The update counter 310 for a replica may be incremented in response to each write request executed with respect to that replica.

Each server 302a-302c may also store and update a candidate list 312 that includes references to replicas that are likely in need of compaction. This determination may be made based on the update counters 310. For example, those replicas having update counters 310 exceeding a threshold may be referenced in the candidate list 312.

As described below, the decision to compact a replica of a storage volume may be made based on actions taken with respect to other replicas of the same storage volume. Accordingly, a server 302d may operate as a coordinator among the servers 302a-302c. The server 302d may also function as a server providing access to replicas stored on its storage device 306d or may operate exclusively as a coordinator. In other embodiments, information sufficient to coordinate among the servers 302a-302c may be shared among the servers 302a-302c and stored on each server 302a-302c such that a dedicated coordinator is not used.

Coordination information may include a list 314 of replicas that are designated as primary. For example, for a given storage volume V1, there may be replicas R1, R2, . . . , RN. A reference to the replica that is primary for volume V1 may be included in the primary list 314, e.g. V1.R2. Likewise, references to replicas that are secondary may be included in a secondary list 316, e.g. V1.R1 and V1.R3, . . . V1.RN, in the illustrated example. In some embodiments, those replicas that are not primary are secondary by default. Accordingly, in such embodiments only a primary list 314 may be maintained. Entries in the lists 314, 316 may include all of an identifier of a storage volume, replica identifier, and an identifier of the server 302a-302c on which the replica is stored.

As described in greater detail below, a coordination method may make decisions based on which replicas are currently being compacted. Accordingly, the coordination information may include a list 318 of replicas that are currently being compacted. As for the list 318, the entries may include some or all of identifiers of a storage volume, a replica, and a server 302a-302c where the replica is stored.

As noted above, the lists 314-318 may be populated with information reported by the servers 302a-302c. Accordingly, when a replica is promoted to primary, references to its corresponding storage volume, replica identifier, and server 302a-302c may be transmitted to the coordinating server 302d or distributed every other server 302a-302c.

In a like manner, when a replica is demoted to secondary this information may also be transmitted or distributed. When a server 302a-302c determines that it will compact a replica, it may transmit or distribute this information such that reference to the replica may be added to the compaction list 318. When a server 302a-302c completes compaction of a replica it may transmit or distribute this information such that reference to the replica may be removed from the compaction list 318.

The coordination information of lists 314-318 may then be accessed by the servers 302a-302c from the coordination server 302d or from locally maintained lists 314-318. Accordingly, in the methods below, references to decisions based on which replica is primary or secondary and which are currently being compacted may be understood to be based on data obtained from the lists 314-318.

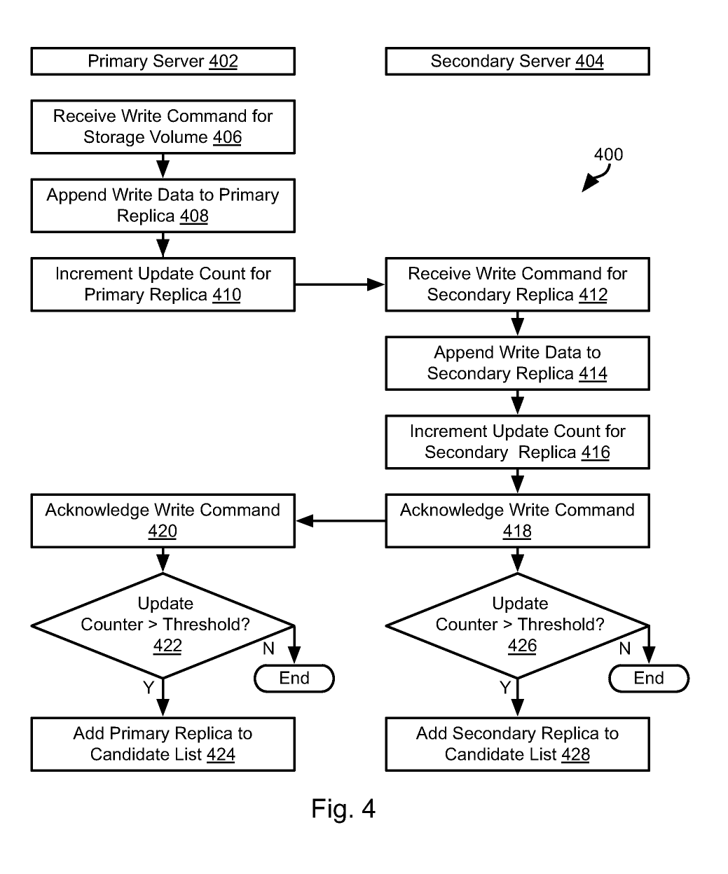

Referring to FIG. 4, the illustrated method 400 is an example of how a write request may be processed in the distributed storage system 300. The method 400 may be executed by a primary server 402 and one or more secondary servers 402. The primary server 402 is the server 302a-302c storing a primary replica of a storage volume referenced in the read request. The one or more secondary servers 404 are the one or more server 302a-302c storing secondary replicas of the storage volume referenced in the read request. Any server 302a-302c may operate as a primary or secondary server 402, 404 and may simultaneously be a primary server 402 for one storage volume and a secondary server 404 for a different storage volume.

The primary server receives 406 a write command from a user application, such as a user application executing on a computer system 308. The write command may be routed to the primary server 402 by way of a coordinating server 302d that evaluates a storage volume referenced in the write command and sends it to the primary server 402 because it is referenced in the primary list 314 as being primary for that storage volume. Alternatively, the computer system 308 may retrieve an identifier for the primary server 402 from the server 302d and transmit the write command directly to the primary server 402.

Upon receiving the write command, the primary server 402 appends 408 the data from the write command to the primary replica of the storage volume referenced in the write command. In the append-only storage model, the write data may include a unique identifier (block address, object key, file name, etc.) and may be written to a file in the primary replica without overwriting any previously-written data addressed to that same unique identifier.

The method 400 may further include incrementing 410 the update counter 310 for the replica to which the data is appended 408. Each update command may include a single object or multiple objects. Accordingly, the update counter 310 may be incremented 410 by the number of objects written by the write command.

The method 400 may further include receiving 412 the write command by the one or more secondary servers 404. The primary server 402 may transmit the write command to the secondary servers 404 or a source of the write command or a router (e.g., coordinating server 302d) of the write commands may transmit the write command to the secondary servers 404.

Upon receiving the write command, the secondary server 404 appends 414 the data from the write command to the secondary replica of the storage volume referenced in the write command in the same manner as for step 408. The secondary server 404 further increments 416 the update counter 310 for the secondary replica of the storage volume referenced in the write command in the same manner as for step 410.

After the data from the write command is successfully appended 414, the secondary server 404 may transmit 418 an acknowledgment to the primary server 402. Upon receiving the acknowledgement from one or more of the secondary servers 404 and upon successfully appending 408 the data from the write command to the primary replica, the primary server 402 acknowledges 420 completion of the write command, such as by transmitting an acknowledgment to a source of the write command, e.g. the user application executing on the computing device 308. In some embodiments, the primary server 402 will acknowledge 420 a write command only after receiving acknowledgments with respect to all of the secondary replicas for the storage volume referenced in the write command.

The method 400 may further include evaluating 422 whether the update counter 310 for the primary replica meets a threshold condition. If so, a reference to the primary replica is added 424 to the candidate list 312 of the primary server 402. Likewise, the update counter 310 for each secondary replica may be evaluated 426. If the update counter 310 for a secondary replica meets the threshold condition, it is added 428 to the candidate list 312 of the secondary server 404 by which it is stored.

In the illustrated embodiment, evaluations 422, 426 are performed for each command. In some instances, to reduce overhead, the evaluations 422, 426 are performed periodically. For example, a server 402, 404 may evaluate the update counters 310 of the replicas it stores periodically (e.g., every 10 s, 1 min, multiple minutes, or some other interval). References to replicas corresponding to update counters 310 meeting the threshold condition may then be added to the candidate list 312.

The threshold for steps 422, 426 may be dynamic such that it is tuned based on multiple factors. For example, the threshold may be a function of multiple factors such as size of a storage device 306a-306c, available space on the storage device 306a-306c, size of the replica corresponding to the update counter 310, and number of replicas stored on the storage device 306a-306c.

For example, the threshold may be reduced as an amount of available space goes down. The threshold for a given replica may increase with size of the replica. The threshold may increase with an increasing loading (read/write commands). As the number of replicas stored by the server 402, 404 goes up, the threshold may be reduced.

In some embodiments, rather than a fixed threshold, the N replicas with the highest update counters 310 will be referenced in the candidate list 312, where N is a predetermined integer that may also be varied (increase as available space decreases on the server 402, 404, decrease with increased loading of the server 402, 404, increase with increasing number of replicas stored by the server 402, 404).

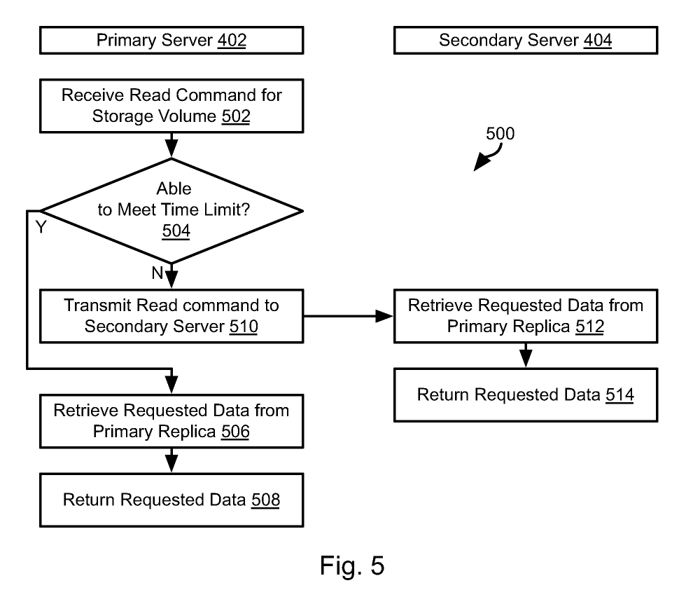

FIG. 5 illustrates a method 500 for processing read commands in a distributed storage system 300. The method 500 may include receiving 502 a read command by the primary server. The manner in which the read command is routed to the primary server 402 storing the primary replica for the storage volume referenced by the read command may be performed in the same manner as described above with respect to write commands.

The primary server 402 may then evaluate 504 its load. If the primary server 402 is able to execute the read command within a predetermined time limit, e.g. a queue of unprocessed read/write commands is less than a threshold size, then the primary server 402 retrieves 506 data referenced in the read command from the primary replica and returns 508 the data to a source of the read command.

If the primary server 402 is unable to execute the read command within a predetermined time limit, e.g. a queue of unprocessed read/write commands is greater than a threshold size, then the primary server may transmit 510 the read command to the secondary server 404 for the storage volume referenced in the read command. the secondary server 404 then retrieves 512 data referenced in the read command from the primary replica and returns 514 the data to a source of the read command.

In some embodiments, if the secondary server 404 is unable to execute the command within a time limit (e.g. according to the same evaluation of step 504), then it may transmit the read command to a different secondary server 404.

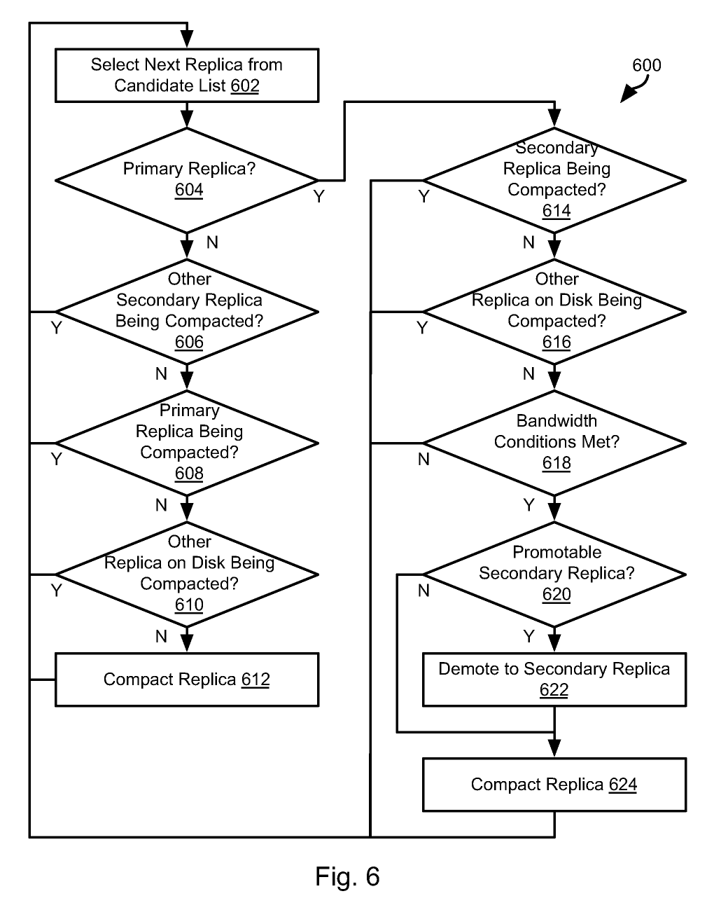

FIG. 6 illustrates a method 600 for coordinating compaction of the various replicas of a same storage volume. The method 600 is executed by each server system 302a-302c, hereinafter the “subject server.” As noted above, the information for coordinating may be obtained from lists 314-318 maintained by a coordinating server 302d or maintained by each individual server 302a-302c.

The method 600 may include selecting 602 a replica (“the subject replica”) from the candidate list 312 of the subject server. The selection 602 may be based on a first in first out approach. Alternatively, the replica having the highest corresponding update count 310 may be selected 602.

The method 600 may include evaluating 604 whether the subject replica is the primary replica for the storage volume of which it is a replica (“the subject storage volume”). If not, the method 600 may include evaluating 606 whether any other secondary replicas of the subject storage volume are currently being compacted. If so, then the method 600 ends with respect to the subject replica and the method 600 repeats with selection 602 of a different replica from the candidate list 312 as the subject replica.

In some embodiments, some maximum number of secondary replicas may be being compacted and the result of step 606 will still be negative (e.g., 1, 2, 3 or some other number that is less than the total number of secondary replicas). This maximum number may be tuned to achieve desired performance.

If the result of step 606 is negative (no compactions or no more than a maximum number of compactions), the method 600 may include evaluating 608 whether the primary replica of the subject storage volume is currently being compacted. If so, then the method 600 ends with respect to the subject replica and the method 600 repeats with selection 602 of a different replica from the candidate list 312 as the subject replica.

If the primary replica is not found 608 to be being compacted, the method 600 may include evaluating 610 whether the subject server is currently compacting any other replicas. If so, then the method 600 ends with respect to the subject replica and the method 600 repeats with selection 602 of a different replica from the candidate list 312 as the subject replica.

If not, then the subject replica is compacted 612. References to the subject replica may also be removed from the candidate list 312 of the subject server and the update counter 310 of the subject replica may be set to zero on the subject server.

Compacting 612 the subject replica may include performing any garbage collection known in the art. In one embodiment, data in the replica is represented as an object store where instances of a data object are stored as a unique key and object data (“key/data pair”). Key/data pairs may be stored in a sequence such that key/data pairs closer to one end of a file are written earlier than key/data pairs that are further from that end of the file. Accordingly, where there are occurrences of the same key in a file, only the later key/data pair is valid and all others are invalid. Compaction therefore includes writing the valid key/data pairs from one or more old files to a new file and deleting the one or more old files such that invalid occurrences of the key are deleted.

If the subject replica is found 604 to be a primary replica, then the method 600 may include evaluating 614 whether any of the secondary replicas of the subject storage volume are currently being compacted and evaluating 616 whether the subject server is currently compacting another replica. If either of these evaluations are positive, then the subject replica is not compacted and the method 600 repeats at step 602 with the selection of a different replica from the candidate list 312 as the subject replica.

In some embodiments, some maximum number of secondary replicas may be being compacted and the result of step 614 will still be negative (e.g., 1, 2, 3 or some other number that is less than the total number of secondary replicas). This maximum number may be tuned to achieve desired performance.

If the evaluations of steps 614 and 616 are negative, the method 600 may include evaluating 618 whether one or more bandwidth conditions are met 618 by the subject server. Step 618 may include implementing one or more of the following evaluations:
Is a current write bandwidth for the subject replica less than a pre-defined threshold?
Is a current time within a predefined window (e.g., between 9 pm and 8 am)?
Is the free storage space on the storage device 306a-306c of the subject server below a predefined limit?

If the result of none of these evaluations that are implemented in a given embodiment is positive, then the subject replica is not compacted and the method 600 repeats at step 602 with the selection of a different replica from the candidate list 312 as the subject replica.

If any of the implemented evaluations of step 618 are positive, then the method 600 may continue by determining 620 whether any of the secondary replicas of the subject storage volume can be promoted to primary. If so, then the primary replica is demoted 622 to secondary, one of the secondary replicas is promoted to primary, and the subject replica is compacted 624, such as described above with respect to step 612.

Whether a secondary replica can be promoted to primary may depend on whether the secondary replica has received all of the same updates (e.g., write and delete commands) as the subject replica. There are many ways that this determination may be made. For example, each update may be assigned a sequence number. If the sequence number of the last update completed by the subject replica is the same as the last update completed by a secondary replica, the secondary replica is available to be promoted to primary.

If there are multiple secondary replicas that can be promoted, then one of them may be selected at random or based on loading (e.g., the secondary replica stored by the least loaded server 302a-302c).

In some instances, no secondary replica is found 620 to be promotable to primary. This is an extremely unlikely scenario. However, where this occurs, the subject replica may be restored to primary, or remain primary, and be compacted 624 anyway.

As is apparent from the description above, the method 600 provides for the completion of compaction in such a way that the impact on user-perceived performance is reduced. In particular, coordination of compaction of secondary replicas and the primary replica reduces the likelihood that execution of read or write commands using the primary replica will be impacted by compaction. Likewise, selecting a different replica a primary when the primary replica is in need of compaction reduces impacts on latency.

The present invention may be embodied in other specific forms without departing from its spirit or essential characteristics. The described embodiments are to be considered in all respects only as illustrative, and not restrictive. In particular, although the methods are described with respect to a NAND flash SSD, other SSD devices or non-volatile storage devices such as hard disk drives may also benefit from the methods disclosed herein. The scope of the invention is, therefore, indicated by the appended claims, rather than by the foregoing description. All changes which come within the meaning and range of equivalency of the claims are to be embraced within their scope.

1. A method comprising:
providing a plurality of computing devices coupled to one another by a network; and
for each storage volume of a plurality of storage volumes—
storing a plurality of replicas of the each storage volume in the plurality of computing devices;
designating a first replica of the plurality of replicas as primary and all other replicas of the plurality of replicas as secondary;
(a) performing a compaction algorithm with respect to one or more replicas of the plurality of replicas of the each storage volume that are designated as secondary by computing devices of the plurality of computing devices storing the one or more replicas;
(b) after performing (a), designating the first replica as secondary and designating a second replica of the plurality of replicas, other than the first replica, as primary; and
(c) after performing (b), performing the compaction algorithm with respect to the first replica by a computing device of the plurality of computing devices storing the first replica.

2. The method of claim 1, wherein performing the compaction algorithm comprises:
writing latest data corresponding to one or more unique data labels to a new file; and
deleting one or more older files storing the latest data corresponding to the one or more unique data labels and older data corresponding to the one or more unique data labels.

3. The method of claim 1, further comprising performing, by each computing device of the plurality of computing devices with respect to a subject replica of the plurality of replicas of a subject storage volume of the plurality of storage volumes stored by the each computing device:
(i) determining that the subject replica is designated as secondary;
(ii) determining that the compaction algorithm is not being performed with respect to any other replicas of the plurality of replicas of the subject storage volume; and
(iii) determining that the each computing device is not currently performing the compaction algorithm; and
in response to determining all of (i), (ii), and (iii), performing, by the each computing device, the compaction algorithm with respect to the subject replica.

4. The method of claim 3, further comprising selecting, by each computing device of the plurality of computing devices, the subject replica by:
receiving a plurality of write requests;
for each write request, incrementing a corresponding update counter for a replica referenced by the each write request;
adding replicas for which the corresponding update counter meets a threshold condition to a candidate list; and
selecting a replica from the candidate list as the subject replica.

5. The method of claim 1, further comprising performing, by each computing device of the plurality of computing devices with respect to a subject replica of the plurality of replicas of a subject storage volume of the plurality of storage volumes stored by the each computing device:
(i) determining that the subject replica is designated as primary;
(ii) determining that the compaction algorithm is not being performed for any other replicas of the subject storage volume;
(iii) determining that the each computing device is not currently performing the compaction algorithm;
in response to determining all of (i), (ii), (iii)—
designating a different replica of the plurality of replicas of the subject storage volume as primary;
designating the subject replica as secondary; and
performing the compaction algorithm for the subject replica.

6. The method of claim 5, further comprising, by the each computing device, selecting the different replica from the plurality of replicas of the subject storage volume by:
identifying one or more current replicas of the plurality of replicas of the subject storage volume that is designated as secondary and is as current as the subject replica; and
selecting the different replica from among the one or more current replicas.

7. The method of claim 1, further comprising performing, by each computing device of the plurality of computing devices with respect to a subject replica of the plurality of replicas of a subject storage volume of the plurality of storage volumes stored by the each computing device:
(i) determining that the subject replica is designated as primary;
(ii) determining that the compaction algorithm is not being performed for any other replicas of the subject storage volume;
(iii) determining that the each computing device is not currently performing the compaction algorithm;
(iv) determining that at least one of a load of write requests for the subject replica is below a threshold, a current time is within a predefined window, and free storage space of the each computing device is below a threshold limit; and
in response to determining all of (i), (ii), (iii), and (iv)—
designating a different replica of the plurality of replicas of the subject storage volume as primary;
designating the subject replica as secondary; and
performing the compaction algorithm for the subject replica.

8. The method of claim 1, for each storage volume of a plurality of storage volumes:
receiving, by a subject computing device of the plurality of computing devices storing the first replica, a write request;
executing, by the computing device, the write request;
transmitting, by the subject computing device, the write request to a plurality of computing devices storing the other replicas of the each storage volume;
(d) receiving, by the subject computing device, acknowledgments from the plurality of computing devices storing the other replicas of the each storage volume; and
in response to (d), transmitting, by the subject computing device, an acknowledgment to a source of the write request.

9. The method of claim 8, further comprising, for each storage volume of a plurality of storage volumes:
receiving, by a subject computing device of the plurality of computing devices storing the first replica, a first read request;
retrieving requested data referenced in the first read request from the first replica;
returning the requested data to a source of the first read request.

10. The method of claim 9, further comprising, for each storage volume of a plurality of storage volumes:
receiving, by the subject computing device of the plurality of computing devices storing the first replica, a second read request;
(d) determining, by the subject computing device, that the second read request cannot be processed within a time limit; and
in response to (d), transmitting, by the subject computing device, the second read request to one of a plurality of computing devices storing the other replicas of the each storage volume.

11. A system comprising:
a plurality of computing devices coupled to one another by a network and storing a plurality of replicas of a plurality of storage volumes, each computing device of the plurality of computing devices programmed to—
for each replica of the plurality of replicas stored by the each computing device, perform compaction of the each replica only if the each replica is designated as secondary for a storage volume of the plurality of storage volumes; and
for each replica of the plurality of replicas stored by the each computing device that is designated as primary, perform compaction of the each replica only after demoting the each replica to be secondary.

12. The system of claim 11, wherein each computing device of the plurality of computing devices is programmed to perform compaction by:
writing latest data corresponding to one or more unique data labels to a new file; and
deleting one or more older files storing the latest data corresponding to the one or more unique data labels and older data corresponding to the one or more unique data labels.

13. The system of claim 11, wherein each computing device of the plurality of computing devices is programmed to, for a subject replica of a subject storage volume of the plurality of storage volumes that is stored on the each computing device:
if all of (i) the each replica is designated as secondary, (ii) the compaction algorithm is not being performed with respect to any other replicas of the subject storage volume that are designated as secondary, and (iii) the each computing device is not currently performing the compaction algorithm, perform compaction of the subject replica.

14. The system of claim 13, wherein each computing device of the plurality of computing devices is programmed to select the subject replica by:
receiving a plurality of write requests;
for each write request, incrementing a corresponding update counter for a replica referenced by the each write request;
adding replicas for which the corresponding update counter meets a threshold condition to a candidate list; and
selecting a replica from the candidate list as the subject replica.

15. The system of claim 11, wherein each computing device of the plurality of computing devices is programmed to, for a subject replica of a subject storage volume of the plurality of storage volumes that is stored on the each computing device, if (i) the subject replica is designated as primary, (ii) the each computing device is not currently performing the compaction algorithm, (iii) a load of write requests for the each computing device is below a threshold, then:
invoke designating of a different replica of the plurality of replicas of the subject storage volume as primary;
designate the subject replica as secondary; and
perform compaction of the subject replica.

16. The system of claim 15, wherein at least one computing device of the plurality of computing devices is programmed to select the different replica from the plurality of replicas of the subject storage volume by:
identifying one or more current replicas of the plurality of replicas of the subject storage volume that is designated as secondary and is as current as the subject replica; and
selecting the different replica from among the one or more current replicas.

17. The system of claim 11, wherein each computing device of the plurality of computing devices is programmed to, for a subject replica of a subject storage volume of the plurality of storage volumes that is stored on the each computing device:
evaluate whether—
(i) the subject replica is designated as primary;
(ii) the compaction algorithm is not being performed for any other replicas of the subject storage volume;
(iii) the each computing device is not currently performing the compaction algorithm;
(iv) at least one of a load of write requests for the each computing device is below a threshold, a current time is within a predefined window, and free space on a storage device of the each computing device is below a threshold limit; and if all of (i), (ii), (iii), and (iv) are true—
invoke designation of a different replica of the plurality of replicas of the subject storage volume as primary;
designate the subject replica as secondary; and
perform the compaction algorithm for the subject replica.

18. The system of claim 11, wherein each computing device of the plurality of computing devices is programmed to:
receive a write request;
execute the write request;
transmit the write request to a plurality of computing devices storing the other replicas of the each storage volume;
(d) receive acknowledgments from the plurality of computing devices storing the other replicas of the each storage volume; and
in response to (d), transmit an acknowledgment to a source of the write request.

19. The system of claim 18, wherein each computing device of the plurality of computing devices is programmed to:
receive a read request;
retrieve data referenced in the read request from a replica referenced by the read request; and
return the data referenced in the read request to a source of the read request.

20. The system of claim 18, wherein each computing device of the plurality of computing devices is programmed to:
receive a read request;
if the read request cannot be processed within a time limit, transmit the read request to one of a plurality of computing devices storing replicas of a storage volume reference by the read request;
if the read request can be processed within a time limit—
retrieve data reference by the read request from a replica of the storage volume referenced by the read request; and
return the data to a source of the read request.
